(19) United States
(12) Patent Application Publication
(10) Pub. No.: US 2011/0101825 A1
(43) Pub. Date: May 5, 2011

(54) PIEZOELECTRIC MOTOR

(76) Inventors: Jung Wook Hwang, Gyunggi-do (KR); Gui Youn Lee, Gyunggi-do (KR); Jung Seok, Gyunggi-do (KR); Hyun Phill Ko, Gyunggi-do (KR)

(21) Appl. No.: 12/642,382

(22) Filed: Dec. 18, 2009

(30) Foreign Application Priority Data
Oct. 30, 2009 (KR) 10-2009-0104228

(51) Int. Cl. H02N 2/04

(52) U.S. Cl. 310/323.02

(57) ABSTRACT

Disclosed herein is a piezoelectric motor. The piezoelectric motor includes a piezoelectric vibrating body, a dummy piezoelectric sheet layer and a contact member. The piezoelectric vibrating body is configured such that piezoelectric sheets on which electrode patterns are printed are stacked on one on another. The dummy piezoelectric sheet layer is provided on the piezoelectric vibrating body. The contact member is provided on the outer surface of the dummy piezoelectric sheet layer. The contact member transmits vibrations generated from the piezoelectric vibrating body to the outside. Therefore, the piezoelectric motor can minimize a problem in which vibration characteristics vary attributable to contact between a contact member and an electrode pattern of a piezoelectric vibrating body.

### CROSS REFERENCE TO RELATED APPLICATION

This application claims the benefit of Korean Patent Application No. 10-2009-0104228, filed Oct. 30, 2009, entitled “Piezoelectric motor”, which is hereby incorporated by reference in its entirety into this application.

### BACKGROUND OF THE INVENTION

1. Technical Field

The present invention relates to a piezoelectric motor.

2. Description of the Related Art

Recently, as a substitute for electromagnetic motors, piezoelectric motors (piezoelectric ultrasonic motors) using piezoelectric material have gained popularity. In piezoelectric motors, a piezoelectric vibrating body generates high frequency vibrations of a fine amplitude and transmits the vibrations to a slider (or rotor) which is in contact with a contact member attached to the piezoelectric vibrating body, thus enabling the slider to conduct fine motion. Compared to prior electromagnetic motors, such a piezoelectric motor has many advantages in that it can be reduced in size, the resolution is high and the noise is reduced.

FIGS. 1A and 1B are views showing the construction of a piezoelectric motor 10, according to a conventional technique: FIG. 1A is an assembled perspective view; and FIG. 1B is a front view.

As shown in FIGS. 1A and 1B, the piezoelectric motor 10 includes a piezoelectric vibrating body 11 and contact members 12. The piezoelectric vibrating body 11 is configured such that piezoelectric ceramic sheets on which electrode patterns are printed are stacked one on top of another. The piezoelectric vibrating body 11 vibrates depending on power applied thereto in an elongation vibration mode in which it expands and contracts in the longitudinal direction, and in a bending vibration mode in which it bends in the thickness direction. The contact members 12 are attached to the outer surface of the piezoelectric vibrating body 11 and transmit vibrations from the piezoelectric vibrating body 11 to the outside. Here, the electrode patterns are formed on the piezoelectric ceramic sheets in a variety of shapes in consideration of a vibration mode and the vibrating to direction of the piezoelectric vibrating body 11, the number of contact members 12 and the locations thereof.

In the piezoelectric motor 10 having the above-mentioned construction, when the piezoelectric vibrating body 11 vibrates in the two vibration modes, the contact members 12 conduct elliptical motion. The elliptical motion of the contact members 12 is transmitted to the slider or rotor, thus making linear motion of the slider or rotation of the rotor possible.

However, in the piezoelectric motor 10 according to the conventional technique, because the contact members 12 are directly attached to the outer surface of the piezoelectric vibrating body 11, the contact members 12 come into contact with the electrode pattern printed on the piezoelectric ceramic sheet, thus affecting the vibration characteristics of the piezoelectric vibrating body 11. In particular, when attaching the contact members 12 to the piezoelectric vibrating body 11, the weight of the contact members 12 varies. The weight variation of the contact members 12 stimulates the electrode patterns and thus affects the driving frequency of the piezoelectric motor 10, thereby making the electric operation and control of the piezoelectric motor 10 difficult.

Meanwhile, to prevent the contact members 12 from coming into direct contact with the corresponding electrode pattern, the position at which the electrode pattern is printed on the piezoelectric vibrating body 11 must be changed. However, because of the recent trend of reducing the size of the piezoelectric motor 10, it is very difficult to change the position of the electrode pattern, so that the degree of freedom in printing of the electrode pattern is markedly reduced.

### SUMMARY OF THE INVENTION

The present invention has been made in an effort to provide a piezoelectric motor which can minimize a problem in which vibration characteristics vary attributable to contact between a contact member and an electrode pattern of a piezoelectric vibrating body.

In a piezoelectric motor according to an embodiment of the present invention, a piezoelectric vibrating body includes piezoelectric sheets stacked one on top of another. An electrode pattern is printed on each of the piezoelectric sheets. A dummy piezoelectric sheet layer is provided on the piezoelectric vibrating body. A contact member is provided on the outer surface of the dummy piezoelectric sheet layer. The contact member transmits vibrations generated from the piezoelectric vibrating body to the outside.

The piezoelectric vibrating body may generate the vibrations when power is applied to the electrode patterns. The vibrations generated by the piezoelectric vibrating body may be transmitted to the contact member through the dummy piezoelectric sheet layer having the piezoelectric sheets stacked one on top of another.

Furthermore, the dummy piezoelectric sheet layer may have a recess having a predetermined depth in a thickness direction. The contact member may be partially embedded in the recess.

The recess may be formed in the dummy piezoelectric sheet layer by depressing a partial area of the dummy piezoelectric sheet layer in the thickness direction.

The recess may have a shape corresponding to a shape of the contact member. The number of recesses may correspond to the number of contact members.

The contact member may have a circular, elliptical or angled cross-section.

The recess may comprise a plurality of recesses formed in the dummy piezoelectric sheet layer. The contact member may comprise a plurality of contact members which are respectively seated into the recesses.

The recess may extend the entire length or the entire width of the dummy piezoelectric sheet layer.

The recess may be formed in a partial area of the dummy piezoelectric sheet layer.

The recess may be formed in the dummy piezoelectric sheet layer in a hole shape, and the contact member may be fitted into the hole-shaped recess.

Furthermore, a portion of the contact member which protrudes outwards from the dummy piezoelectric sheet layer may have a round shape.

In addition, at least a portion of the recess in the dummy piezoelectric sheet layer may have a width greater than a width of a mouth of the recess.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are views illustrating the construction of a piezoelectric motor, according to a conventional technique;

FIGS. 2A through 2C are views illustrating the construction of a piezoelectric motor, according to a first embodiment of the present invention;

FIGS. 3A through 3C are views illustrating the construction of a piezoelectric motor, according to a second embodiment of the present invention;

FIGS. 4A through 4C are views illustrating several modifications of the piezoelectric motor shown in FIGS. 3A through 3C;

FIGS. 5A through 5C are views illustrating the construction of a piezoelectric motor, according to a third embodiment of the present invention; and

FIGS. 6A through 6C are views illustrating several modifications of the piezoelectric motor shown in FIGS. 5A through 5C.

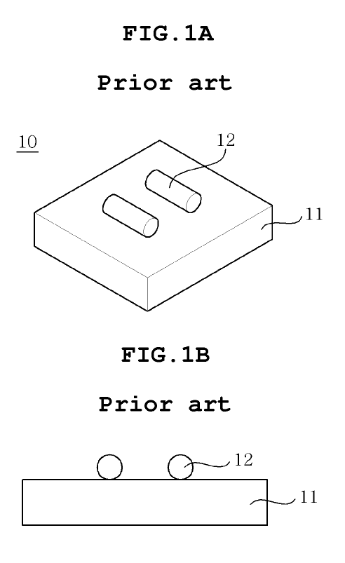

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, embodiments of the present invention will be described in detail with reference to the attached drawings.

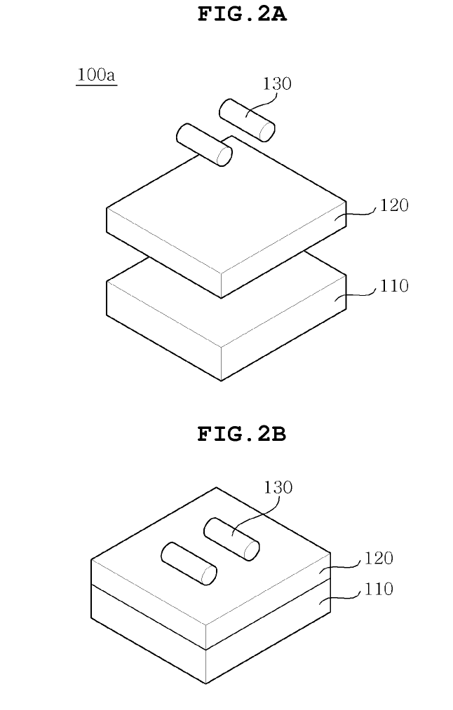

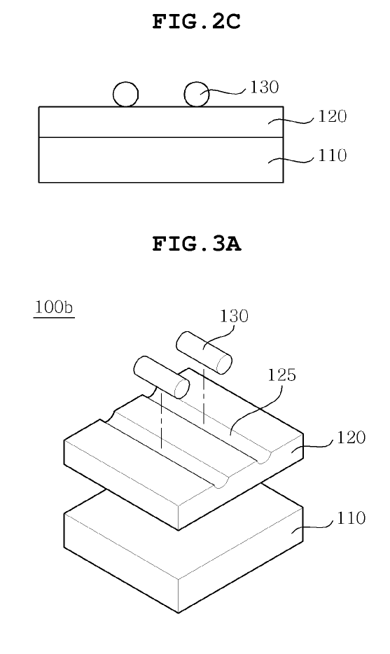

FIGS. 2A through 2C are views illustrating the construction of a piezoelectric motor, according to a first embodiment of the present invention: FIG. 2A is an exploded perspective view; FIG. 2B is an assembled perspective view; and FIG. 2C is a front view. Below, a piezoelectric motor 100a according to the first embodiment will explained in detail with reference to FIGS. 2A through 2C.

As shown in FIGS. 2A through 2C, the piezoelectric motor 100a according to the first embodiment includes a piezoelectric vibrating body 110, a dummy piezoelectric sheet layer 120 and contact members 130.

The piezoelectric vibrating body 110 generates vibrations (provides a vibration mode) using the change in shape when power is applied thereto. The piezoelectric vibrating body 110 is configured such that piezoelectric sheets (piezoelectric ceramic sheets) on which electrode patterns are formed are stacked one on top of another. Here, to when the electrode patterns printed on the surfaces of the piezoelectric sheets are appropriately set, the piezoelectric vibrating body 110 can provide a first vibration mode and a second vibration mode, for example, an elongation vibration mode which generates vibrations in the longitudinal direction of the piezoelectric vibrating body 110, and a bending vibration mode which generates vibrations in the thickness direction of the piezoelectric vibrating body 110. Here, the first vibration mode and the second vibration mode are not limited to these, in other words, the first and second vibration modes are not limited to a special vibration mode so long as the contact members 130 can conduct elliptical motion. Furthermore, the structure of stacking the piezoelectric sheets of the piezoelectric vibrating body 110 and the structure of the electrode patterns formed on the piezoelectric sheets are well known to those skilled in this art, therefore further explanation will be omitted.

The dummy piezoelectric sheet layer 120 is provided on the piezoelectric vibrating body 110 to provide space for installation of the contact members 130. The dummy piezoelectric sheet layer 120 comprises a single piezoelectric sheet having no electrode pattern or is configured such that piezoelectric sheets having no electrode pattern are stacked one on another. Furthermore, the dummy piezoelectric sheet layer 120 is interposed between the piezoelectric vibrating body 110 and the contact members 130 to prevent the contact members 130 from coming into direct contact with the piezoelectric vibrating body 110 and transmit vibrations generated from the piezoelectric vibrating body 110 to the contact members 130.

The contact members 130 transmit vibrations generated from the piezoelectric vibrating body 110 to an external substance (for example, a rotor, a slider or the like). The contact members 130 are provided on the outer surface of the dummy piezoelectric sheet layer 120 and are made of ceramic or cemented carbide.

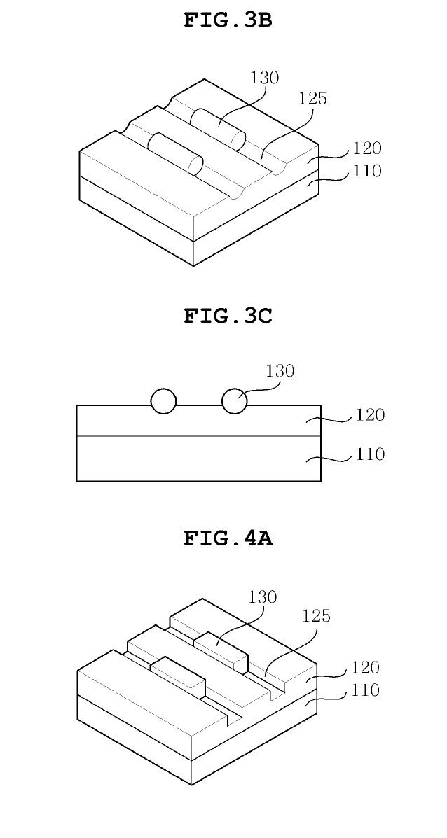

FIGS. 3A through 3C are views illustrating the construction of a piezoelectric to motor 100b, according to a second embodiment of the present invention: FIG. 3A is an exploded perspective view; FIG. 3B is an assembled perspective view; and FIG. 3C is a front view. Below, the piezoelectric motor 100b according to the second embodiment of the present invention will be explained in detail with reference to FIGS. 3A through 3C. In the following description of the second embodiment, the same reference numerals will be used to designate the components corresponding to those of the first embodiment, and the explanation of the overlapped portions will be omitted.

As shown in FIGS. 3A through 3C, in the piezoelectric motor 100b according to the second embodiment, recesses 125 are formed in a dummy piezoelectric sheet layer 120 to predetermined depths in the thickness direction thereof. Contact members 130 are provided on the dummy piezoelectric sheet layer 120 in such a way that portions of the contact members 130 are embedded in the recesses 125. As such, in the case where the contact members 130 are partially embedded in the recesses 125, a problem of weight variation of the contact members 130 when attached to the dummy piezoelectric sheet layer 120 affecting the driving frequency of the piezoelectric motor 100b can be minimized Therefore, the piezoelectric motor 100b can be effectively operated/controlled. Furthermore, a contact area between the dummy piezoelectric sheet layer 120 and the contact members 130 increases, so that the intensity with which the contact members 130 are attached to the dummy piezoelectric sheet layer 120 can increase. In addition, because the contact members 130 are fixed to the recesses 125, the installation positions of the contact members 130 remain constant, thus avoiding a problem of variation of the resonant frequency possibly being caused if the installation positions of the contact members 130 are unstable.

In the embodiment, the recesses 125 are formed in the dummy piezoelectric sheet layer 120 to appropriate depths such that the contact members 130 seated into the recesses 125 do not come into contact with the electrode patterns of the piezoelectric vibrating body to 110.

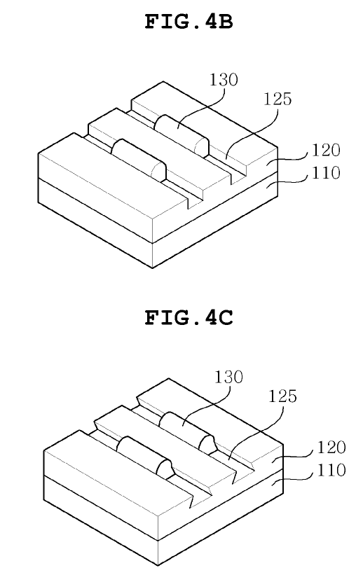

Furthermore, the recesses 125 have shapes corresponding to the contact members 130, and the number of recesses 125 depends on that of the contact members 130. For example, if the two or more contact members 130 are required in consideration of contact locations, the number of contact portions, the contact area, etc. between the contact members 130 and the rotor or slider which is connected to the contact members 130 to conduct elliptical motion, the number of recesses 125 corresponding to the number of the contact members 130 is formed in the dummy piezoelectric sheet layer 120 such that the every contact member 130 can be seated into a corresponding recess 125. Meanwhile, in FIGS. 3A through 3C, although each contact member 130 is illustrated as having a cylindrical structure having a circular or elliptical cross-section, and each recess 125 is illustrated as having a recessed cylindrical shape and extending the entire length or width of the dummy piezoelectric sheet layer 120, the contact member 130 can have a variety of shapes depending on the structure of a portion thereof which is in contact with the rotor or slider. This will be explained in more detail in the description of FIGS. 4A through 4C.

FIGS. 4A through 4C are assembled perspective views illustrating several modifications of the piezoelectric motor shown in FIGS. 3A through 3C. Hereinafter, various shapes of the contact member 130 and the recesses 125 will be explained with reference to FIGS. 4A through 4C.

As shown in FIGS. 4A through 4C, each contact member 130 may not only have a circular cross-section but also have an angled cross-section (refer to FIG. 4A). Furthermore, the portion of the contact member 130 which protrudes outwards from the dummy piezoelectric sheet layer 120 and comes into contact with the slider or rotor may have a round surface, for example, having a semi-circular or elliptical cross-section (refer to FIG. 4B).

Moreover, to prevent the contact member 130 from being removed from the recess 125, at least a portion of the recess 125 in the dummy piezoelectric sheet layer 120 may have a width greater than that of the mouth of the recess 125 (refer to FIG. 4C). For example, the recess 125 may be configured such that the width thereof increases from the mouth thereof to the inside. In the case of this structure, the recess 125 serves as an anchor for preventing removal of the contact member 130 fitted into the recess 125. In addition, the contact member 130 can be fitted into the recess 125 in such a way as to slide the contact member 130 from one end of the recess 125 thereinto in the longitudinal direction of the recess 125.

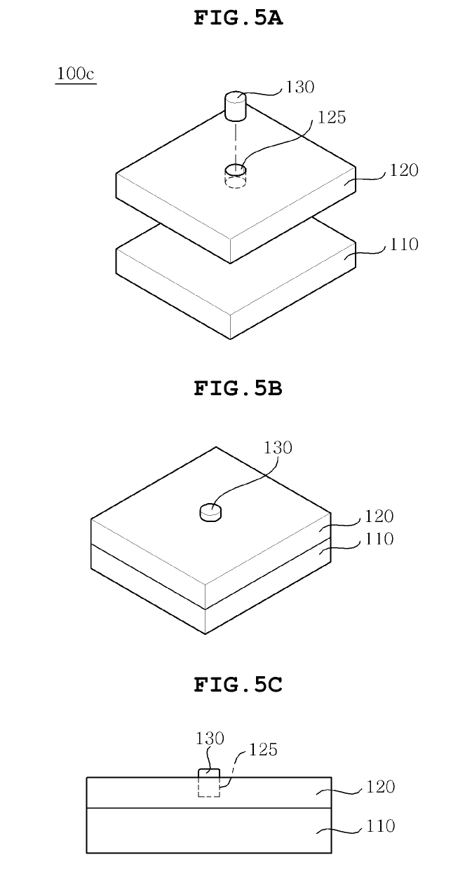

FIGS. 5A through 5C are views illustrating the construction of a piezoelectric motor 100c, according to a third embodiment of the present invention: FIG. 5A is an exploded perspective view; FIG. 5B is an assembled perspective view; and FIG. 5C is a front view. Below, the piezoelectric motor 100c according to the third embodiment of the present invention will be explained in detail with reference to FIGS. 5A through 5C.

As shown in FIGS. 5A through 5C, the piezoelectric motor 100c according to the third embodiment is characterized in that a recess 125 is formed in a partial area of the dummy piezoelectric sheet layer 120 rather than extending the entire length or width of the dummy piezoelectric sheet layer 120. In the third embodiment, the recess 125 is formed in the dummy piezoelectric sheet layer 120 in a hole shape. A contact member 130 is fitted into the hole-shaped recess 125. For example, the recess 125 having a hole shape is formed in the central portion of the dummy piezoelectric sheet layer 120. The contact member 130 has a cylindrical shape having a circular or elliptical cross-section and is fitted into the hole-shaped recess 125.

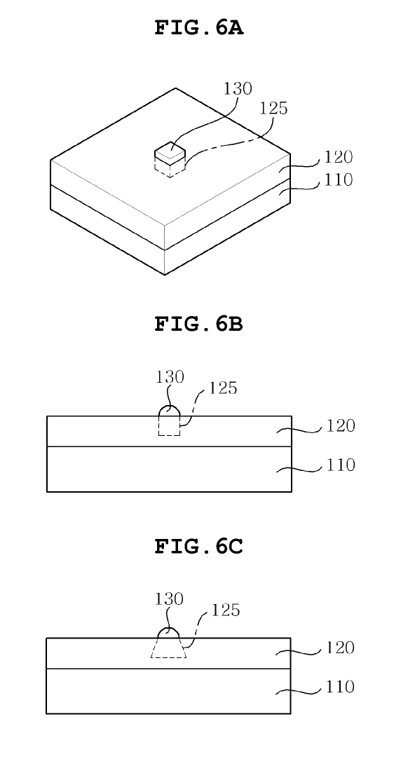

FIGS. 6A through 6C are assembled perspective views illustrating several modifications of the piezoelectric motor shown in FIGS. 5A through 5C. Hereinafter, various shapes of the contact member 130 and the recess 125 will be explained with reference to FIGS. 6A through 6C.

As shown in FIGS. 6A through 6C, the contact member 130 may have a prism shape having an angled cross-section (refer to FIG. 6A). Furthermore, the portion of the contact member 130 which protrudes outwards from the dummy piezoelectric sheet layer 120 and comes into contact with the slider or rotor may have a round surface, for example, having a semi-circular or elliptical cross-section (refer to FIG. 6B).

Moreover, to prevent the contact member 130 from being removed from the recess 125, at least a portion of the recess 125 in the dummy piezoelectric sheet layer 120 may have a width greater than that of the mouth of the recess 125 (refer to FIG. 6C).

As described above, in a piezoelectric motor according to the present invention, a contact member is disposed on a dummy piezoelectric sheet layer provided on a piezoelectric vibrating body. Therefore, variation in vibrating characteristics attributable to contact between an electrode pattern and the contact member can be minimized

Furthermore, the contact member may be partially embedded in a recess of the dummy piezoelectric sheet layer. In this case, a degree with which attachment of the contact member to the dummy piezoelectric sheet layer affects the driving frequency of the piezoelectric motor can be minimized In addition, because a contact area between the contact member and the dummy piezoelectric sheet layer increases, the intensity with which the contact member is attached to the dummy piezoelectric sheet layer is enhanced. As well, the installation position of the contact member on the dummy piezoelectric sheet layer is reliably retained, thus avoiding a problem of variation of the resonant frequency which may be induced if the installation position of the contact member is unstable.

Moreover, at least a portion of the recess in the dummy piezoelectric sheet layer may have a width greater than that of the mouth of the recess. In this case, the contact member can be reliably prevented from being removed from the dummy piezoelectric sheet layer.

Although the embodiments of the present invention have been disclosed for illustrative purposes, it will be appreciated that the piezoelectric motor of the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A piezoelectric motor, comprising:
a piezoelectric vibrating body comprising piezoelectric sheets stacked one on top of another, with an electrode pattern printed on each of the piezoelectric sheets;
a dummy piezoelectric sheet layer provided on the piezoelectric vibrating body; and
a contact member provided on an outer surface of the dummy piezoelectric sheet layer, the contact member transmitting vibrations generated from the piezoelectric vibrating body to an outside.

2. The piezoelectric motor as set forth in claim 1, wherein the piezoelectric vibrating body generates the vibrations when power is applied to the electrode patterns, and
the vibrations generated by the piezoelectric vibrating body are transmitted to the contact member through the dummy piezoelectric sheet layer having the piezoelectric sheets stacked one on top of another.

3. The piezoelectric motor as set forth in claim 1, wherein the dummy piezoelectric sheet layer has a recess having a predetermined depth in a thickness direction, and the contact member is partially embedded in the recess.

4. The piezoelectric motor as set forth in claim 3, wherein the recess is formed in the dummy piezoelectric sheet layer by depressing a partial area of the dummy piezoelectric sheet layer in the thickness direction.

5. The piezoelectric motor as set forth in claim 3, wherein the recess has a shape corresponding to a shape of the contact member, and the number of recesses corresponds to the number of contact members.

6. The piezoelectric motor as set forth in claim 3, wherein the contact member has a circular, elliptical or angled cross-section.

7. The piezoelectric motor as set forth in claim 3, wherein the recess comprises a plurality of recesses formed in the dummy piezoelectric sheet layer, and the contact member comprises a plurality of contact members which are respectively seated into the recesses.

8. The piezoelectric motor as set forth in claim 3, wherein the recess extends an entire length or an entire width of the dummy piezoelectric sheet layer.

9. The piezoelectric motor as set forth in claim 3, wherein the recess is formed in a partial area of the dummy piezoelectric sheet layer.

10. The piezoelectric motor as set forth in claim 3, wherein the recess is formed in the dummy piezoelectric sheet layer in a hole shape, and the contact member is fitted into the hole-shaped recess.

11. The piezoelectric motor as set forth in claim 3, wherein a portion of the contact member which protrudes outwards from the dummy piezoelectric sheet layer has a round shape.

12. The piezoelectric motor as set forth in claim 3, wherein at least a portion of the recess in the dummy piezoelectric sheet layer has a width greater than a width of a mouth of the recess.
